(19) United States
(12) Patent Application Publication
(10) Pub. No.: US 2009/0022035 A1
(43) Pub. Date: Jan. 22, 2009

(54) SPHERICAL ABERRATION CORRECTION CONTROL

(75) Inventors: Yung-chih Li, Hsin-Chu City (TW); Chao-ming Huang, Hsin-Tien City (TW)

Correspondence Address: MADSON & AUSTIN, 15 WEST SOUTH TEMPLE, SUITE 900, SALT LAKE CITY, UT, 84101, US

(73) Assignee: MEDIATEK Inc., Hsin-Chu (TW)

(21) Appl. No.: 11/779,118

(22) Filed: Jul. 17, 2007

(51) Int. Cl. G11B 7/00

(52) U.S. Cl. 369/112.02

(57) ABSTRACT

A controller and a control method is provided to control a spherical aberration correcting device provided in an optical pick-up head to change a spherical aberration compensate value according to different controlling states during the spherical aberration correcting device changes the spherical aberration compensate value. For the mechanical type spherical aberration correcting device, the controlling states are the different speeds for the actuators to drive the lenses. For the liquid crystal type spherical aberration correcting device, the controlling states are the control values for the driver to drive liquid crystal spherical aberration corrector.

### TECHNICAL FIELD OF THE INVENTION

The present invention relates to spherical aberration correction of an optical pick-up head of an optical disc system, more particularly to a spherical aberration correction controller and a spherical aberration correction control method for the spherical aberration correcting device of the pick-up head in the optical disc system.

### BACKGROUND OF THE INVENTION

For an optical disc system, an optical pick-up head is used to perform reading/writing operation to an optical disc. In the optical pick-up head, a laser beam from a laser diode is focused on the disc through a lens. A spherical aberration phenomenon, which influences light angle of the focused light and therefore causing the optical focus signal to degrade, occurs especially for high NA (numerical aperture) optical disc system such as a blue-ray disc (BD) system. In the case that NA of an object lens of the optical pick-up head is greater than 0.8, spherical aberration correction is indispensable.

There are various types of discs available in current market. Different types of discs may have different thicknesses. In addition, even discs of the same type may have different thicknesses due to manufacturing divergence. Further, multilayer discs are widely used today. In some specific cases, even different formats of recording layers are combined in a single disc. For a single lens pick-up head for multiple types of discs, to perfectly focus the light on discs of different thicknesses or different layers of the same disc, different spherical aberration compensation (correction) values are required.

To correct the spherical aberration, a spherical aberration correcting device is utilized in the optical pick-up head. FIG. 1 is a simplified diagram schematically showing utilization of a mechanical spherical aberration correcting device. As shown, a light beam is focused on a disc 10 via an object lens 20. A spherical aberration correcting lens group 30 including a first lens 32 and a second lens 34 is provided. It is noted that the “first lens” may indicate a lens group. Similarly, the “second lens” may indicate another lens group. By changing a distance between the first lens 32 and the second lens 34 of the spherical aberration lens group 30, the spherical aberration of the optical disc system can be properly corrected. The movement of the first lens 32 and the second lens 34 is achieved by controlling spherical aberration correction actuators 40.

FIG. 2 is a simplified diagram schematically showing utilization of a liquid crystal spherical aberration correcting device. In this structure, a liquid crystal spherical aberration corrector 50 is used. The liquid crystal spherical aberration corrector 50 is driven by a driver 55.

As shown in FIG. 3 showing a relationship diagram of control command value versus time (t), if the driver 55, which originally drives the liquid crystal spherical aberration corrector 50 under an original control command value, say, spherical aberration compensation setting value A, is given another constant control command value B. The driver 55 then drives the liquid crystal spherical aberration corrector 50 under the constant control command value B until the target spherical aberration compensate value is achieved. The time point that the target spherical aberration compensate value is achieved is marked as Tₜ. Such an operation takes several milliseconds.

When an optimal spherical aberration compensate value is to be determined for a specific point of the disc 10, a try-and-error scheme is usually utilized. That is, different spherical aberration compensate values are tried to find the optimal one among those values. In another condition, when the light focus point of the pick-up head is to jump from a current layer to another layer in a multilayer disc, which is referred to as “interlayer jump”, the spherical aberration compensate value also needs to be changed. To change the spherical aberration compensate value, the lens 32, 34 of the mechanical spherical aberration correcting device have to be moved to predetermined positions by the actuators 40. Such a movement takes decades of milliseconds, in some conditions, even takes hundreds of milliseconds. If the liquid crystal spherical aberration correcting device is used, to change the spherical aberration compensate value, as mentioned it also takes several milliseconds.

### SUMMARY OF THE INVENTION

In accordance with an aspect of the present invention, the controller for controlling a spherical aberration correcting device used in an optical pick-up head of an optical disc system is provided. The spherical aberration correcting device is used for providing a spherical aberration compensate value. The controller controls the spherical aberration correcting device with two or more controlling states during the spherical aberration correcting device changes the spherical aberration compensate value.

In accordance with another aspect of the present invention, the method for controlling a spherical aberration correcting device used in an optical pick-up head of an optical disc system is provided. The spherical aberration correcting device provides a spherical aberration compensate value for compensating the spherical aberration of the optical pick-up head. The method comprises controlling the spherical aberration correcting device to change the spherical aberration compensate value with a first controlling state during the spherical aberration correcting device changes a spherical aberration compensate value from a first value to a second value; and controlling the spherical aberration correcting device to change the spherical aberration compensate value with a second controlling state different from the first controlling state during the spherical aberration correcting device changes a spherical aberration compensate value from the first value to the second value.

The spherical aberration compensate value is to be changed when the optical pick-up head moves from a first position to a second position of a disc to execute an operation, when an optimal spherical aberration compensate value is to be found for a specific position of a disc by trying different spherical aberration compensate values or when the optical pick-up head accesses to different discs.

According to embodiments of the present invention, the controlling states are different driving speeds for a mechanical type spherical aberration correcting device, for example. Alternatively, the controlling states are different control values for a liquid crystal type spherical aberration correcting device, for example. The controlling states can be other control factors for other types of spherical aberration correcting devices.

### BRIEF DESCRIPTION OF THE DRAWINGS

FIG. 1. is a simplified diagram schematically showing a conventional mechanical type spherical aberration correcting device used in an optical pick-up head;

FIG. 2. is a simplified diagram schematically showing a conventional liquid crystal type spherical aberration correcting device used in an optical pick-up head;

FIG. 3 is a diagram showing a relationship between control command value and time in prior art;

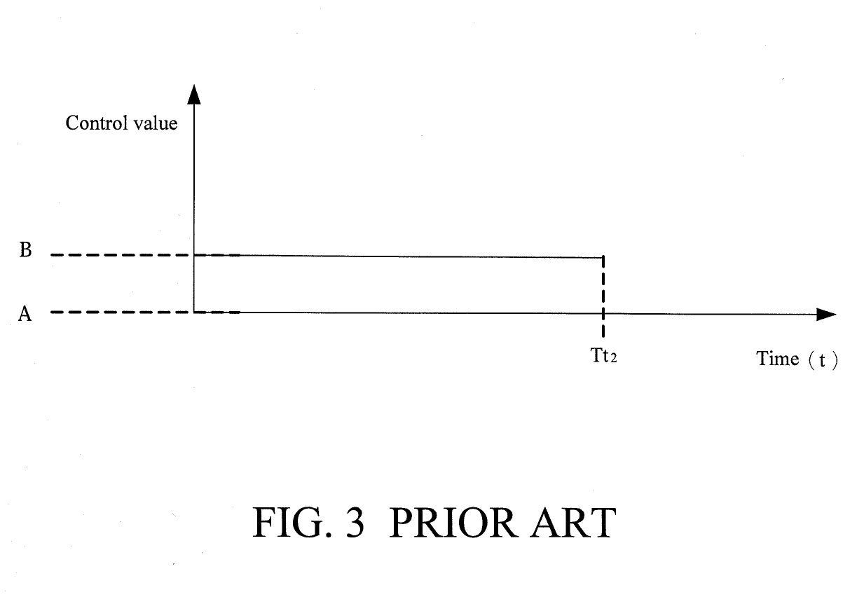

FIG. 4 is a simplified diagram schematically showing a spherical aberration correction system in accordance with the present invention in accordance with the present invention;

FIG. 5 is a diagram showing a driving speed profile;

FIG. 6 is a diagram showing a relationship between control command value and time in accordance with the present invention;

FIG. 7 illustrates corresponding variation of driving speed of the spherical aberration correcting device and spherical aberration compensate value during interlayer jump interval of the optical pick-up head in accordance with an embodiment of the present invention;

FIG. 8 illustrates corresponding variation of driving speed of the spherical aberration correcting device and spherical aberration compensate value during interlayer jump interval of the optical pick-up head in accordance with another embodiment of the present invention; and

FIG. 9 illustrates corresponding variation of driving speed of the spherical aberration correcting device and spherical aberration compensate value during interlayer jump interval of the optical pick-up head in accordance with a further embodiment of the present invention.

### DETAILED DESCRIPTION OF THE INVENTION

The present invention will be described in detail in conjunction with the appending drawings.

For a mechanical or liquid crystal type spherical aberration correcting device used in an optical pick-up head of an optical disc system, spherical aberration compensate value of the spherical aberration correcting device is adaptively adjusted for different positions of the same layer of an optical disc, different layers of a multilayer disc or different discs to correct a wavefront of a light beam emitted from a laser diode, so that optical signals can be obtained in the optimal state.

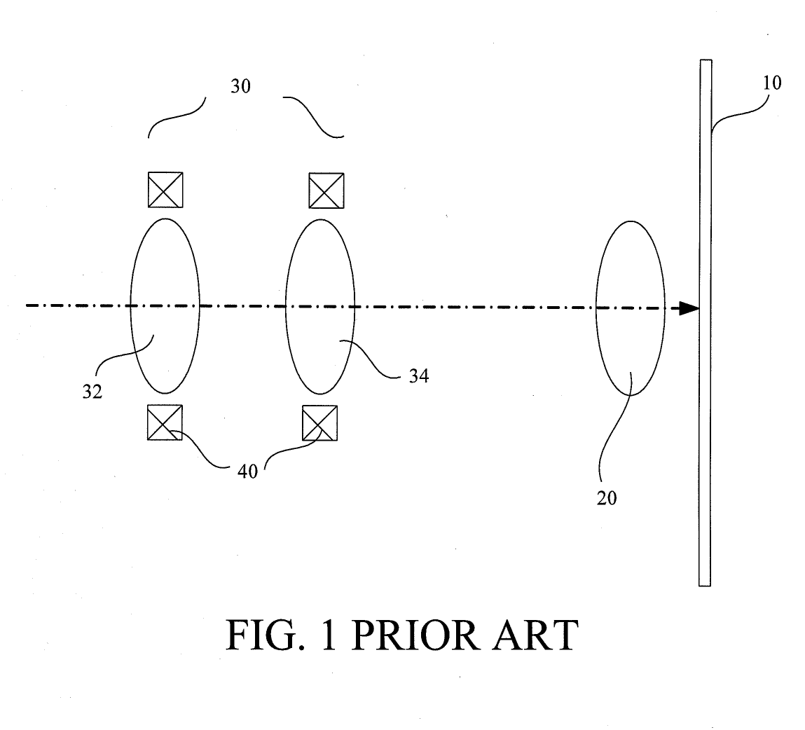

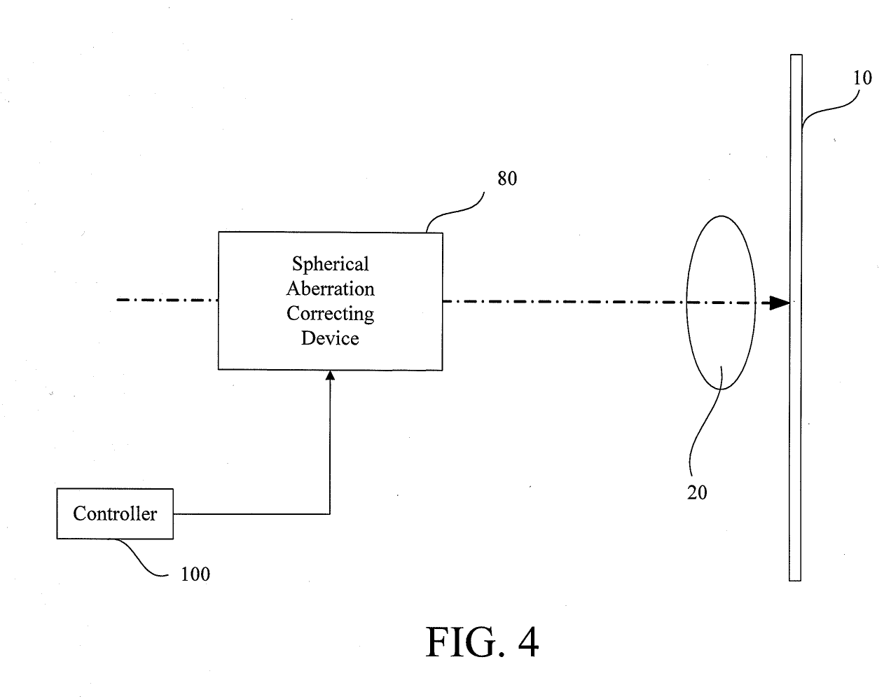

Now please refer to FIG. 4, which is a simplified diagram schematically showing a spherical aberration correction system in accordance with the present invention. A spherical aberration correcting device is indicated by reference number 80, which can be mechanical type or liquid crystal type, etc. In addition, a controller 100 in accordance with the present invention is used. The reference numbers of FIG. 4 the same as those in FIG. 1 indicate the same components, respectively. In a case that the spherical aberration correcting device 80 used in the optical pick-up head is mechanical type, which can be also referred to FIG. 1, during a procedure of determining an optimal spherical aberration compensate value for a specific position of the optical disc, or during a procedure of setting different spherical aberration compensate values for various types of discs, the lenses of the spherical aberration correcting lens group 30 of the mechanical spherical aberration correcting device has to be driven to different positions in order to change spherical aberration compensate value. If the spherical aberration correcting actuators 40 move at a very high driving speed in the beginning, a focus signal of the optical pick-up head is inclined to be degraded. That is, the focus signal may be unreliable. According, a common scheme is to drive the spherical aberration correcting lens group with a constant low driving speed to avoid diving failure. However, when the required spherical aberration compensate value is great, that is, the distances for the spherical aberration correcting lenses to shift are quite long, the adjustment for the actuators 40 will take a significantly long period of time. In addition, when the correction has be to executed for many times, that is, the actuators 40 have to move for many times, a very long time period is also required. As mentioned, it is possible that decades or even hundreds of milliseconds are required. For the sake of convenience of description, herein the spherical aberration correcting lens group is also referred to as “spherical aberration corrector”, in addition, the actuators in combination are referred to “a driving unit”.

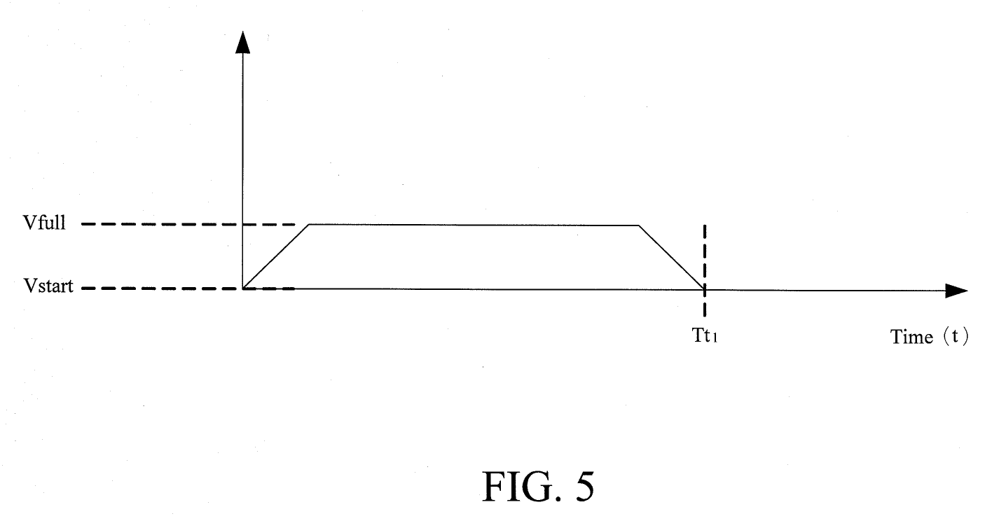

As shown in FIG. 4, the spherical aberration correction controller 100 in accordance with the present invention is used. In an embodiment of the present invention, the spherical aberration correction controller 100 controls the actuators 40 to drive the spherical aberration correcting lens group 30 with the highest start driving speed Vₛₜₐᵣₜ within an acceptable range in the beginning. Then the driving speed is accelerated to a full driving speed V_{full}. When a target spherical aberration compensate value is approximately reached, the driving speed is lowered. The driving speed profile is shown in FIG. 5. By using such a driving speed profile, in which more than two driving speeds are used, driving time is reduced while performance of the pick-up head can be maintained. As described, a low driving speed is used in the early stage of the whole driving procedure. After the driving operation becomes smooth, the driving speed can be lifted to a higher driving speed (e.g. full driving speed). Therefore, the time period that the spherical aberration correcting actuators 40 moves the lenses 32, 34 of the spherical aberration correcting group 30 to target positions can be shortened. The driving speed profile for the mechanical spherical aberration correcting actuators 40 shown in FIG. 5 is preferred for a condition that a new disc is read by the optical pick-up head, for example. Any proper driving speed profile can be designed or programmed as required.

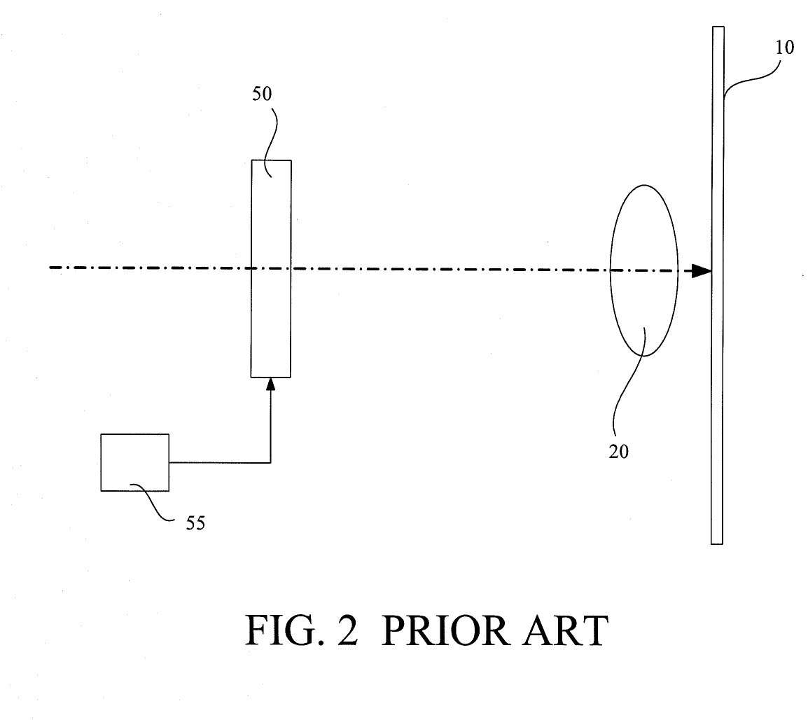

In a case that the spherical aberration correcting device 80 used in the optical pick-up head is liquid crystal type, which can be also referred to FIG. 2, during a procedure of determining an optimal spherical aberration compensate value for a specific position of the optical disc, or during a procedure of setting different spherical aberration compensate values for various types of discs, liquid crystal molecules of the liquid crystal spherical aberration corrector 50 must be driven by a driving unit, the driver 55, to appear a specific arrangement. As described, in conventional driving schemes, the driver takes several milliseconds to drive the liquid crystal spherical aberration corrector under the constant control command value until the target spherical aberration compensate value is achieved.

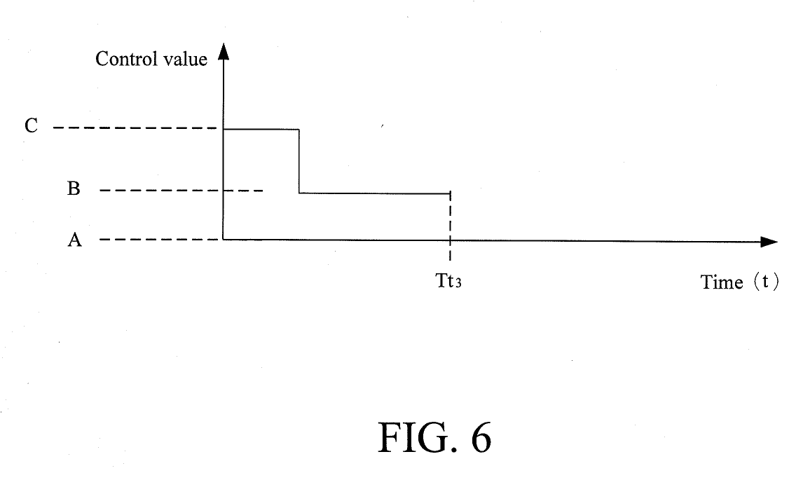

To shorten the time period for the liquid crystal spherical aberration corrector 50 to achieve the target spherical aberration compensate value, the spherical aberration correction controller 100 in accordance with the present invention gives a higher spherical aberration compensation setting value, that is, control value C, to over drive the liquid crystal spherical aberration corrector 50. Then the control value is pulled down to the control value B, as shown in FIG. 6, which is a relationship diagram showing control command value versus time (t). By doing so, the time point that the target spherical aberration compensate value is achieved becomes earlier than prior art. Accordingly, the time period for the liquid crystal spherical aberration corrector 50 to achieve the target spherical aberration compensate value is reduced. The control scheme for the liquid crystal spherical aberration correcting device shown in FIG. 6 is preferred for a condition that a new disc is read by the optical pick-up head, for example. Any proper control scheme can be designed or programmed as required.

As described, the spherical aberration correction controller 100 in accordance with the present invention controls the mechanical or liquid crystal type spherical aberration correcting device with two or more controlling states during the spherical aberration correcting device changes the spherical aberration compensate value. For the mechanical type spherical aberration correcting device, the controlling states are the different speeds for the actuators 40 to drive the lenses 32, 34. For the liquid crystal type spherical aberration correcting device, the controlling states are the control values for the driver 55 to drive liquid crystal spherical aberration corrector 50. However, the controlling states are not limited to the above, any other proper factors can be taken as the controlling state depending on the utilization conditions.

To shift the pick-up head of the optical disc system from a first position to a second position, as mentioned, the spherical aberration compensate value needs to be changed. If the first position and the second position are disposed at the same layer of the disc, the driving speed profile or driving speed control scheme can be similar to those described above. In a further embodiment, spherical aberration correction control for the operation “interlayer jump” will be described as follows.

For a multilayer disc, when the pick-up head shifts from an original data layer to another data layer to read or write data, in addition to the focus point of the light beam has to be changed from the original data layer to the new data layer, the spherical aberration compensate value also needs to be changed. Taking the mechanical spherical aberration correcting device as example, in conventional solutions, the spherical aberration correcting actuators 40 move with a constant driving speed to target positions during a focus actuator (not shown) executes the interlayer jump operation to change the focus point. If the driving speed of the spherical aberration correcting actuators 40 is too fast, it is easy to cause a focus signal of the pick-up head unstable, resulting in a failure of the interlay jump operation. In the other hand, if the driving speed is too slow, time waste is introduced. Furthermore, if the target spherical aberration compensate value is achieved too late, the interlayer jump may also fail.

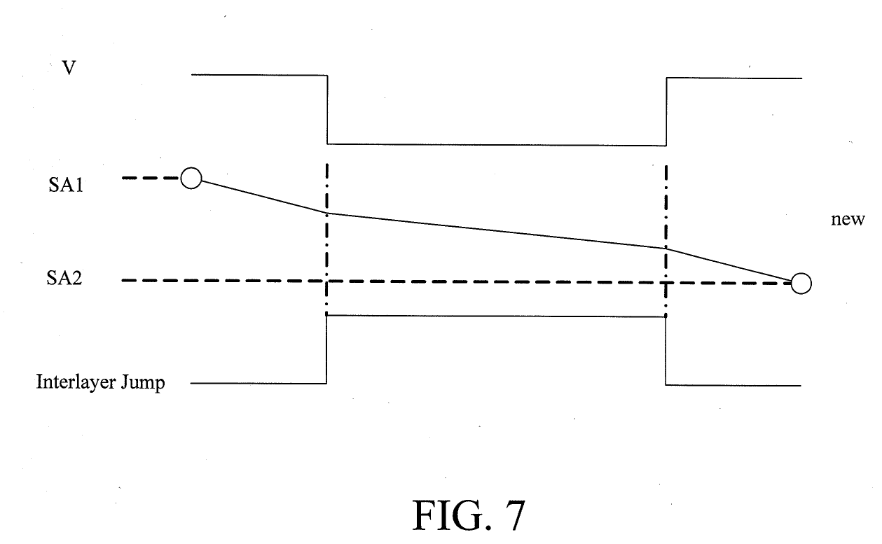

FIGS. 7, 8 and 9 respectively illustrates different driving speed control profiles of spherical aberration correction for interlayer jump procedure. That is, the pick-up head aims from a first layer to a second layer. It is noted that the first and second layers herein may be adjacent to each other or may be separated from each other with other layer(s) interposed therebetween. These cases will be described by taking the mechanical spherical aberration correcting device as example. However, the liquid crystal spherical aberration correcting device is not meant to be eliminated. In these three cases, an original spherical aberration compensate value SA1 for the first layer (original layer) is to be changed to a target spherical aberration compensate value SA2 for the second layer.

With reference also to FIG. 7 as well as FIG. 4 and also FIG. 1, in accordance with the present invention, for the interlayer jump procedure, the controller 100 at first instructs the actuators 40 to drive each of the spherical aberration correcting lenses 32, 34 to an intermediate position at a higher driving speed before the interlayer jump operation actually starts. When the focus actuator (not shown) starts to execute interlayer jump operation, the controller 100 instructs the actuators 40 to use a lower driving speed to move the lenses, so as to avoid from the focus signal being unstable. After the focus actuator completes the interlayer jump operation, the spherical aberration correcting actuators 40 can be driven with a higher driving speed if the target spherical aberration compensate value has not been reached yet.

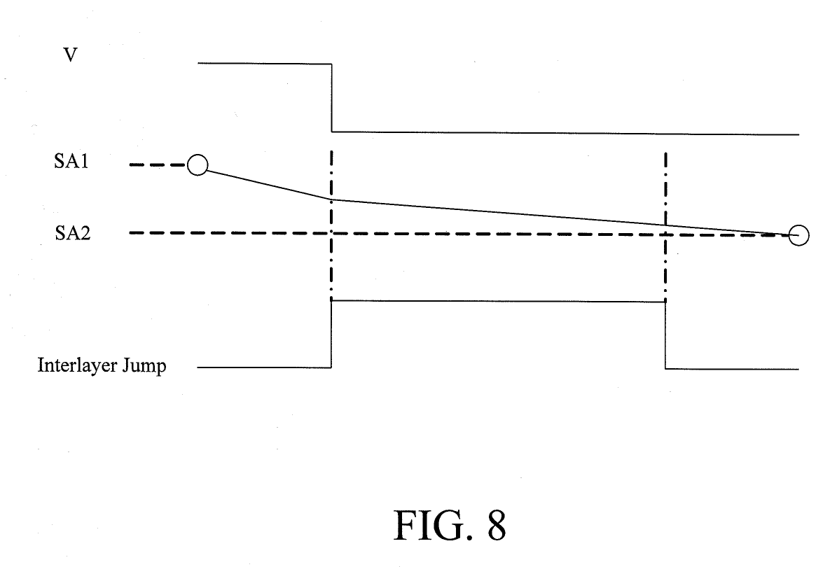

In case that successive operations such as tracking and seeking are to be executed after the interlayer jump operation, the spherical aberration correcting actuators 40 can maintain the same low driving speed to drive the lenses even after the focus actuator has finished the interlayer jump operation, as shown in FIG. 8.

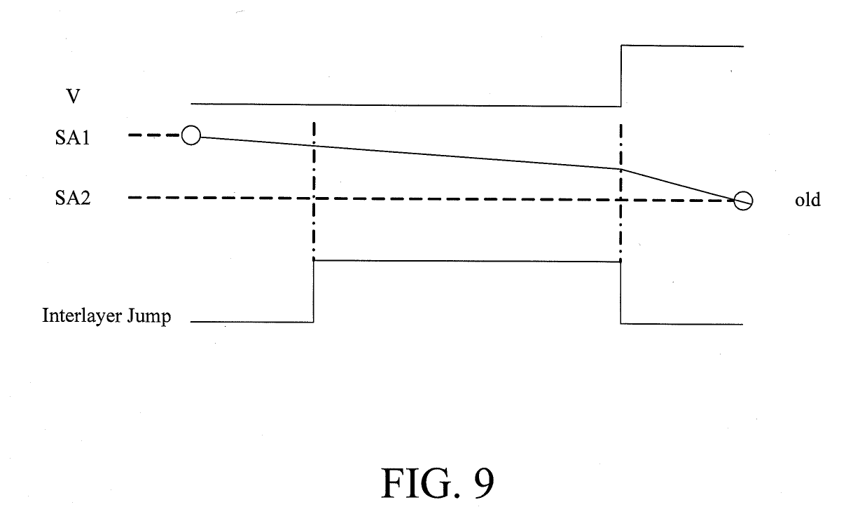

As shown in FIG. 9, it is also possible for the spherical aberration correcting actuators 40 to drive the lenses with a low driving speed before and during the process of the interlayer jump operation. After the interlayer jump operation is completed, the driving speed is lifted so that the target spherical aberration compensate value can be reached more rapidly. This driving speed control scheme is suitable for an optical pick-up head of which the spherical aberration correcting actuators 40 are old and therefore cannot operate at a high driving speed in the beginning of movement, for example. Other objectives for the acturators 40 to utilize a low driving speed in the beginning include decreasing vibration, reducing starting friction, and power saving etc.

Although the above cases are described by taking the mechanical type spherical aberration correcting device as example, those control profiles or schemes are also possible to be used in the case the liquid crystal type spherical aberration correcting device is utilized. Furthermore, the control profiles and schemes are described for exemplarity, any other proper control profile or scheme can be also used, depending on the actual demands.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. A controller for controlling a spherical aberration correcting device used in an optical pick-up head of an optical disc system, said spherical aberration correcting device used for providing a spherical aberration compensate value, wherein said controller controls the spherical aberration correcting device with two or more controlling states during the spherical aberration correcting device changes the spherical aberration compensate value.

2. The controller of claim 1, wherein the spherical aberration compensate value is to be changed when the optical pick-up head moves from a first position to a second position of a disc to execute an operation

3. The controller of claim 1, wherein the spherical aberration compensate value is to be changed when an optimal spherical aberration compensate value is to be found for a specific position of a disc by trying different spherical aberration compensate values

4. The controller of claim 1, wherein the spherical aberration compensate value is to be changed when the optical pick-up head accesses to different discs.

5. The controller of claim 1, wherein when the spherical aberration compensate value is changed from a first value to a second value, the spherical aberration compensate value is firstly changed from the first value to a third value, and then changed from the third value to the second value.

6. The controller of claim 5, wherein the third value lies between the first and second values.

7. The controller of claim 1, wherein the controlling states are driving speeds of the spherical aberration correcting device.

8. The controller of claim 7, wherein a lowest one of driving speeds is utilized during the focus point of the optical pick-up head is moving from a first layer to a second layer of a multilayer disc.

9. The controller of claim 1, wherein the controlling states are different control values of the spherical aberration correcting device.

10. A method for controlling a spherical aberration correcting device used in an optical pick-up head of an optical disc system, said spherical aberration correcting device providing a spherical aberration compensate value for compensating the spherical aberration of the optical pick-up head, said method comprising:
controlling the spherical aberration correcting device to change the spherical aberration compensate value with a first controlling state during the spherical aberration correcting device changes a spherical aberration compensate value from a first value to a second value; and
controlling the spherical aberration correcting device to change the spherical aberration compensate value with a second controlling state different from the first controlling state during the spherical aberration correcting device changes a spherical aberration compensate value from the first value to the second value.

11. The method of claim 10, wherein the spherical aberration compensate value is firstly changed from the first value to a third value, and then changed from the third value to the second value.

12. The method of claim 11, wherein the third value lies between the first and second values.

13. The method of claim 10, wherein the spherical aberration compensate value is changed from the first value to the second value for an operation that a focus point of the optical pick-up head moves from a first layer to a second layer of a multilayer disc.

14. The method of claim 10, wherein the first and second controlling states are different driving speeds of the spherical aberration correcting device.

15. The method of claim 14, wherein a lowest one of the driving speeds is utilized during the focus point of the optical pick-up head is moving from the first layer to the second layer of the multilayer disc.

16. The method of claim 10, wherein the controlling states are different control values of the spherical aberration correcting device.

17. A method for controlling a mechanical spherical aberration correcting device used in an optical pick-up head of an optical disc system, said spherical aberration correcting device providing a spherical aberration compensate value for compensating the spherical aberration of the optical pick-up head, said method comprising:
setting a specific driving speed profile including speed variation; and
instructing the spherical aberration correcting device to change a spherical aberration compensate value from the first value to the second value according to the specific driving speed profile.

18. The method of claim 17, wherein the spherical aberration compensate value is firstly changed from the first value to a third value, and then changed from the third value to the second value.

19. The method of claim 18, wherein the third value lies between the first and second values.

20. The method of claim 17, wherein the spherical aberration compensate value is changed from the first value to the second value for an operation that a focus point of the optical pick-up head moves from a first layer to a second layer of a multilayer disc.

21. The method of claim 20, wherein a lowest driving speed of the driving speed profile is utilized during the focus point of the optical pick-up head is moving from the first layer to the second layer of the multilayer disc.

22. A method for changing a spherical aberration compensate value from a first value to a second value, said method comprising:
setting a first driving speed for changing the spherical aberration compensate value from the first value to an intermediate value; and
setting a second driving speed for changing the spherical aberration compensate value from the intermediate value to the second value.
